(19) United States
(12) Patent Application Publication
(10) Pub. No.: US 2025/0242998 A1
(43) Pub. Date: Jul. 31, 2025

(54) REVERSE VENDING SYSTEM AND METHOD

(71) Applicant: ASOFTA RECYCLING CORPORATION LTD., Yokneam Illit (IL)

(72) Inventors: Yaron BARDUGO, Yokneam Illit (IL); Liron PORAT, Hod HaSharon (IL)

(21) Appl. No.: 18/854,464

(22) PCT Filed: Apr. 4, 2023
(86) PCT No.: PCT/IL2023/050365

§ 371 Date: Oct. 4, 2024

Related U.S. Application Data
(60) Provisional application No. 63/327,580, filed on Apr. 5, 2022.

(51) Int. Cl. B65F 1/14; B02C 23/02; B02C 23/08; B07C 5/34; G06K 7/14

(52) U.S. Cl. CPC B65F 1/14; B02C 23/02; B02C 23/08; B07C 5/3408; B65F 2210/169; G06K 7/1413

(57) ABSTRACT

RV system configured to receive, accept, recognize and identify containers made of various materials for sorting, processing and storing each processed material separately.

### FIELD OF THE INVENTION

The present invention generally relates to a reverse vending (RV) system and, more particularly, to an RV system configured to receive, accept, recognize and identify containers made of various materials for sorting, processing and storing each processed material separately.

### BACKGROUND OF THE INVENTION

Reverse vending machines (RVMs) are configured to accept used and empty containers such as beverage or food containers, etc., in order to recycle and reuse the materials forming said containers. RVMs are usually popular in territories that have mandatory recycling laws or packages deposit legislation. Commonly, recycling programs and platforms provide an incentive to a user in the form of coupons or some kind of reward. The funding of the operation of RVMs may come from manufactures of containers that are obligated to pay funds into a centralized pool to be disbursed to users who returned containers for recycling while some funding protocols may include using excess funds for general environmental initiatives.

Some RVMs are configured to accept empty containers into a receiving opening one at a time and in some RVMs, the user inserts multiple empty containers at once. The containers may then be automatically sorted by various technologies in order to determine their type (such as plastic, metal, glass, cardboard, paper, etc.). For example, a beverage container may be scanned by an omnidirectional universal product code (UPC) scanner configured to scan the beverage QR container's UPC which commonly is evident on container by a readable barcode or QR code. In another example, an RVM may consider a container's form, embossing, material or codes other identification parameters to try and match the container against a computerized database in addition to or instead of its barcode.

Once a container is scanned, identified (matched to database) and determined to be a participating container, thereby enabling the appropriate user refunding, it may be further processed and crushed or shredded in order to reduce its size, and hence, increase the RVM storage capacity and/or avoid future spillages of liquid still contained within.

Current RVMs sort and in some cases, compress or shred collected containers. The distribution of RVMs having shredders and receptacles configured to collect containers made of various materials has been affected by the fact that traditional shredding or crushing RVMs produce a mixture of flakes comprising various materials such as glass, aluminum, plastic, paper or cardboard and thereby present a challenge with regard to further processing by market-recycling companies. This further processing is commonly considered a barrier to recycling due to the costs involved in sorting and processing the mixed materials due to, for example, the presence of contaminant materials, such as PVC and other undesirable types of materials such as plastic, glass, metal, etc.

Prior art such as U.S. Pat. No. 8,851,265 discloses an RVM which accepts deposits of only two types of materials and primarily non-metallic and metallic beverage containers for processing. The beverage containers are inserted by the user into an intake chute, where they are then compacted, sorted, and deposited in storage bins contained within the RVM. The transaction data related to the operation of the RVM is processed by a computer and stored electronically. The said publication further discloses separate storage bins for compacted metallic beverage containers and compacted non-metallic beverage containers. While the said publication addresses the sorting of the containers' materials into two categories—metallic and non-metallic—it does not disclose separation of various and different containers made of more than two materials of which recyclable containers are commonly made (such as various tints and types of plastic, various types of metal, various tints and types of glass, etc.). More so, said publication does not disclose the handling of more than two types of materials.

Thus, there is a need to provide an RV system that presents that capability to process and sort at least more than two types of container materials. For example, a system sub-set for clear/transparent and light blue plastic; a system sub-set for glass material; and a system sub-set for processing metal and color plastic, etc. Said RV system may further sort and process containers into specific receptacles in accordance with market and regulative needs and constrains, making the processed material a desirable raw material almost immediately available for recycling concerns and purposes. This need is further compounded by the varying material properties of these different materials, and thus the range of different processes required to effectively reduce the volume of said range of materials. For example, technologies for the effective volume-reduction of aluminum are not suitable for glass, cardboard, or plastic, nor are the technologies for the effective volume reduction of these materials suitable for each other.

There is a further need to provide an RV system that reduces the volume of recyclable containers made from the at least three main materials used to produce recyclable containers and hence, enable transportation efficiency while reducing the industry's carbon footprint.

### SUMMARY OF THE INVENTION

The following embodiments and aspects thereof are described and illustrated in conjunction with systems, devices and methods which are meant to be exemplary and illustrative and not limiting in scope. In various embodiments, one or more of the above-described problems have been reduced or eliminated, while other embodiments are directed to other advantages or improvements.

The current invention proposes an RV system and method that both sorts and reduces the volume of recyclable containers commonly made from at least three main materials used to produce recyclable containers (typically clear/transparent and light blue plastic, other colored plastic, metal, glass) and hence, enables transportation and downstream processing efficiency while reducing the industry's carbon footprint. Such an RV system is configured to accept a variety of recyclable containers made out of various materials as well as composite materials, sort and process said containers into a compact form and store the processed materials within designated receptacles configured to separately store each material, hence, such an RV system provides a well sorted raw material ready for further processing by recycling companies.

According to one aspect of the invention, a reverse vending RV system is to comprise: (i) at least one image capturing device, (ii) a sorting apparatus, (iii) at least three sets of processors, and (iv) at least three sets of receptacles, (v) an interface compartment having an intake chute, and (vi) a controller configured to control the operation of the RV system, wherein the intake chute is configured to accept containers made out of various types of recyclable materials, whereby the sorting apparatus is configured to autonomously sort any container inserted into the intake chute, wherein each processor is configured to process containers made from predetermined materials, wherein controller is configured to control the diversion of processed container to appropriate receptacle, and wherein each receptacle is configured to store processed containers made of predetermined specific materials.

According to another embodiment of the invention said RV system is to be further configured to accept and autonomously sort a bundle of multiple containers made of various materials jointly loaded into the intake chute According to another embodiment of the invention said RV system wherein intake chute is coupled with a hopper to enable the handling of large batches of containers to be processed.

According to another embodiment of the invention said RV system is further configured to accept and autonomously sort a single container made out from various materials while operated by a single user operating the system through a user-friendly interface.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention.

In the Figures:

FIG. 1 constitutes a schematic perspective view of an RV system, according to some embodiments of the invention.

FIG. 2 constitutes a schematic perspective view of an RV system, according to some embodiments of the invention.

FIG. 3A constitutes a schematic perspective view of a plastic and metal processor, forming a part of an of a RV system, according to some embodiments of the invention.

FIG. 3B constitutes a schematic perspective view of a glass processor, forming a part of an of a RV system, according to some embodiments of the invention.

FIG. 4A constitutes a schematic perspective view of a sorting apparatus, forming a part of an of an RV system, according to some embodiments of the invention.

FIG. 4B constitutes a schematic perspective view of a conveyor apparatus, forming a part of an of an RV system, according to some embodiments of the invention.

FIG. 5A constitutes a schematic perspective view of a detection apparatus forming a part of an of an RV system, according to some embodiments of the invention.

FIG. 5B constitutes a schematic perspective view of a detection apparatus forming a part of an of an RV system, according to some embodiments of the invention.

FIG. 6 constitutes an operation flow chart describing various operations of an RV system, according to some embodiment of the invention.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “controlling” “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, a cloud computing system or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform or component that may be provisioned with a Central Processing Unit (CPU) or microprocessors, and may be provisioned with several input/output (I/O) ports, for example, a general-purpose computer such as a personal computer, laptop, tablet, mobile cellular phone, controller chip, SoC or a cloud computing system.

Configuring the sorting process prior to processing with processors allows the described RV system to optimize both processes, the former by maintaining container integrity and thus improving sorting accuracy; and the latter by enabling the use of several specific processes to reduce the volume of several specific materials with varying material properties. Different containers fabricated from different materials require a range of different processes in order to efficiently reduce their volume, a range the breadth of which is facilitated only by an effective sorting process prior to volume-reduction, as disclosed in this invention. Furthermore, the sorting process of the present invention is configured to be after a user has provided a material input, thereby reducing the demand on users to pre-sort their recyclable material, which improves both general usability and in particular the rate of material input provided by users.

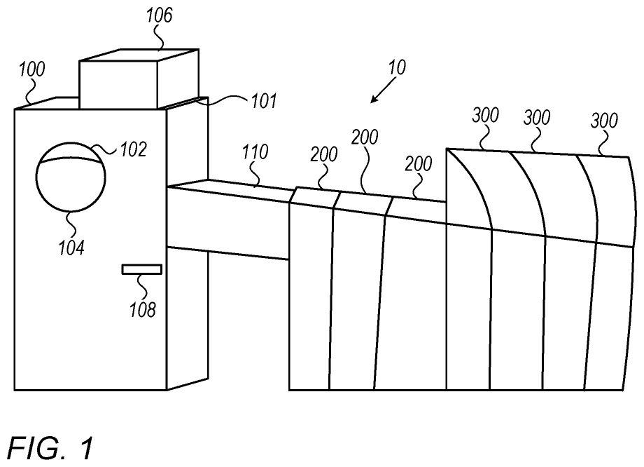

Reference is now made to FIG. 1 which schematically illustrates an RV system 10. As shown, RV system 10 is configured to accept a variety of recyclable containers made out of various materials as well as composite materials, sort and process said containers into a compact form and store the processed materials within designated receptacles configured to separately store each material, hence, RV system 10 provides a well sorted raw material ready for further processing by recycling companies.

According to some embodiments, RV system 10 is also configured to issue any kind of recycling incentive to its users such a coupons, etc. According to some embodiments, the RV system 10 is also configured to process and store all transaction data related to its operation including the date, time, user ID, beverage container type barcode, coupon data, etc. According to some embodiments, RVM system 10 may be configured to operate in various operation modes such as On, Standby, speed and Off states.

According to some embodiments, RVM system 10 comprises at least three sets of processors 200 that may be, for example, shredders, compressors, etc., and further comprises at least three sets of storage receptacles 300. As shown, each processor 200 is designated to process different materials, for example, one processor 200 may be configured to process white and light blue plastic, another processor 200 may be configured to process glass material, another processor 200 may be configured to process metal and other color plastic, etc.

According to some embodiments, each processor 200 may be configured with a service opening that may further be configured with a safe locking mechanism. According to some embodiments, each processor 200 comprises processing elements such as blades, grinding components or shredding meshes, etc. Preferably, the processing elements are replaceable either on site or in a designated service center.

According to some embodiments, any one of processors 200 is designed such that during the processing operation, no particles will be reverted back through the container insertion route and create a potential risk to the user. According to some embodiments, a processor 200 configured to process glass containers is designed to prevent long glass bottles or other elongated containers made of non-buckling material from being pushed vertically backward by the shredder or crusher blades and potentially causing damage to said blades or apparatus.

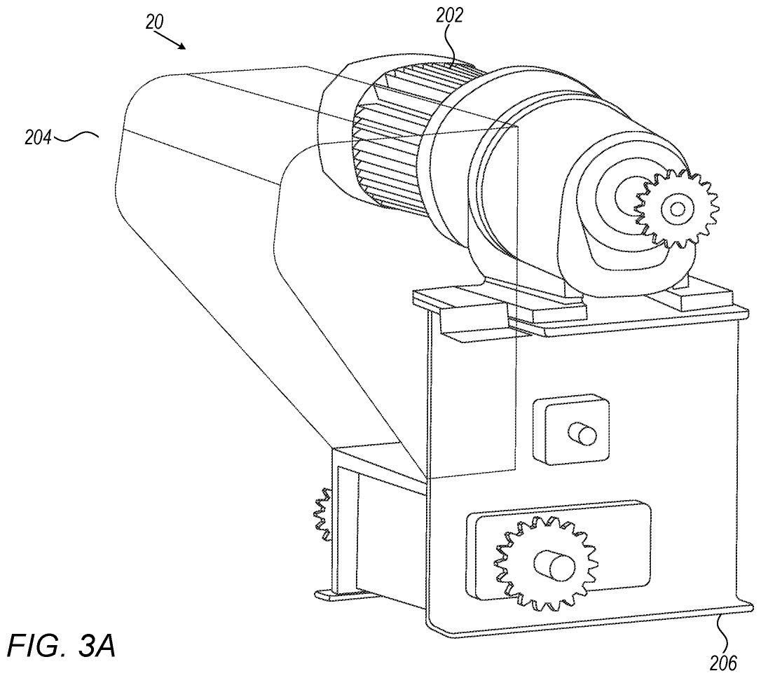

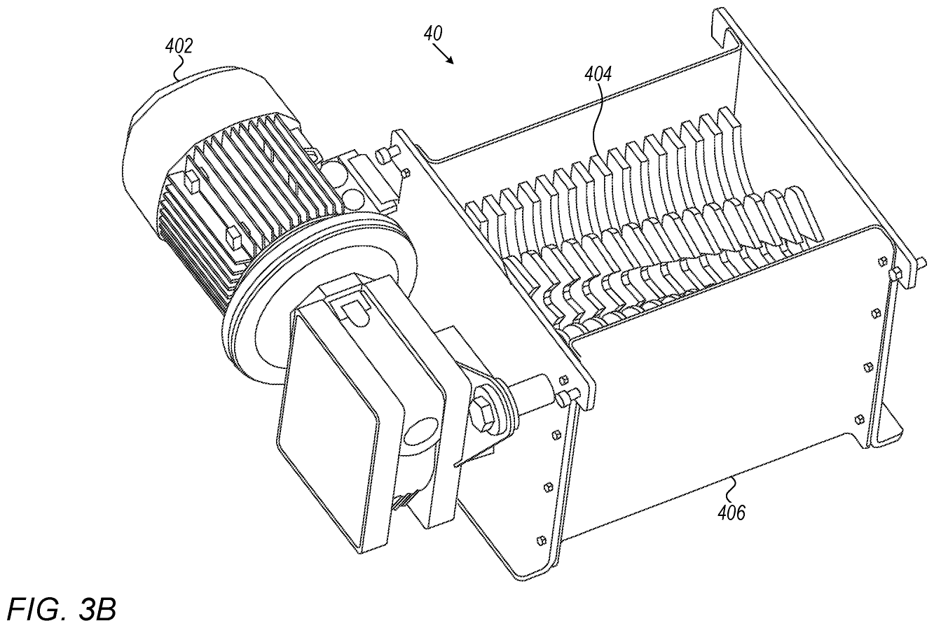

According to some embodiments, each processor 200 may be configured to shred or crush containers to several flakes' predefined size, for example:
1. Glass processor 200 (40 in detailed FIG. 3B)—Min 20 mm, Max 40 mm flakes size
2. Plastic processor 200 (20 in detailed FIG. 3A)—Min 10 mm, Max 20 mm flakes size
3. Aluminum processor 200 (20 in detailed FIG. 3A)—Min 20 mm, Max 40 mm flakes size.

According to some embodiments, each storage receptacles 300 is clearly marked to indicate the material stored within. This “fool proof” design may help the recycling company's personnel to empty each storage receptacle 300 into a suitable other receptacles (such as the ones found on a collection truck) or to concentrate them in common size bales, for further processing. According to some embodiments, each storage receptacle 300 may be equipped with wheels and/or forklift slots in order to facilitate maneuvering and uploading. According to some embodiments, each storage receptacle 300 may be equipped with a spreading element that enhances flattening the flakes hill that may be formed within a receptacle 300 in accordance with spillage input area.

According to some embodiments, interface compartment 100 comprises an intake door 102 configured to alternatively cover an intake chute 104 designated to allow a user to load a variety of containers into the RV system 10. According to some embodiments, the intake chute 104 may accept a large number of containers per minute. For example, intake chute 104 may typically accept 45 or more containers per minutes. According to some embodiments, the intake chute 104 may be located in a convenient location enabling an easy access to the user. For example, the intake chute 104 may typically be located approximately 1200 mm above floor level.

According to some embodiments, interface compartment 100 further comprises at least one user interface component such as screen 106 configured to be mounted upon and provide messages, instructions and feedback to a user using the RV system 10. For example, screen 106 may be mounted on interface compartment 100 such that users may conveniently view relevant information such as user instructions, transaction information, rewards eligibility, advertisements, etc.

According to some embodiments, the RV system 10 may be located in an indoor, relatively public, space such as a supermarket, warehouses, public garages, etc., and may also be adapted to be located in an outdoor location or space.

According to some embodiments, the RV system 10 is designated to accept containers made of various materials loaded at the same time. For example, a user may load a mixed bundle of containers made of various types of plastic, metal, glass, etc., into the intake chute 104 of the RV system 10 without the need to pre-sort the bundle. According to some embodiments, intake chute 104 is coupled with a hopper having a wide opening and relatively large capacity volume intake—the size of such hopper being appropriate to the potential rate of acceptance of the RV system 10 at intake chute 104. In cases where the input rate varies significantly, including to rates significantly higher than the throughput afforded by an embodiment of the invention, a hopper coupled to the intake chute ensures no jams in said input chute.

According to some embodiments, the RV system 10 is designated to accept individual containers made of various materials inserted one by one into intake chute 104. For example, a user may load an individual container made of various types of plastic, metal, glass, etc., into the intake chute 104 of the RV system 10 and continue loading another one, etc.

According to some embodiments, the RV system 10 is designated to accept containers in various shapes and sizes, for example, a user may load a bundle of containers ranging from personal beverages to household cleaning products into the intake chute 104 of the RV system 10 without the need to pre-sort it.

According to some embodiments, the RV system 10 is designated to accept disfigured/deformed containers that may prohibit traditional RV systems from recognizing and diverting containers into a suitable processor 200. For example, a user may load an assortment or containers that have been squashed or partially crushed and therefor un-recognizable by traditional RVMs. In such embodiments, the RV system 10 may apply various technologies in order to identify the composition of said disfigured or deformed containers.

According to some embodiments, interface compartment 100 may further include a slot 108 configured to provide printed output to the user, for example, at the end of the recycling process the user may be awarded with a coupon for buying at a certain store or other form of acknowledgement of receipt.

According to some embodiments, a printer (not shown) may be embedded within the RV system 10 and configured to produce an output such as a receipt designated to be collected by the user to be provided through slot 108. According to some embodiments, the printer may produce a voucher representing a reward given to the user in accordance with his recycling volume, container types or any other desired parameter. According to some embodiments, the printer vouchers may include a unique ID for each voucher for various vending and retail operations.

According to some embodiments, RV system 10 is designated to sort and shred various containers made of various materials and separately store the shredded flakes within specific flakes storage receptacles 300, hence making the shredded material acceptable by recycling companies as disclosed above.

According to some embodiments, said operation of shredding the processed containers into flakes may assist in reducing the volume of the raw material provided for further processing at recycling companies and thus, may significantly contribute to the efficiency of its transportation while reducing the carbon footprint of the whole recycling process. According to some embodiments, the process of diverting the shredded flakes into a suitable storage receptacle 300 is configured to prevent undesirable mixing between flakes made of different materials.

According to some embodiments, an intermediate section 110 is configured to provide a connection between user interface compartment 100 and processors 200 such that interface compartment 100 is accessible to users while the processing operations are conducted in a distant location. Such an arrangement may provide more installation flexibility, enabling to locate the various compartments of the RV system 10 in preferred locations. According to some embodiments, locating processors 200 in a distant location such as behind a wall, may reduce the noise levels generated by the operation of the RV system 10. According to some embodiments, average noise levels produced by the operation of the RV system 10 shall be limited to less than 60 dBA allowing for glass crushing events that may produce higher noise levels for short periods of time.

According to some embodiments, after a container/s has been inserted to chute 104, a conveyer (not shown) is configured to convey said container/s through chute 104 and into the processors 200. According to some embodiments, designated conveyor/s may be located within intermediate section 110 and/or within the interface compartment 100 in order to collect and convey a container immediately after being inserted through chute 104.

According to some embodiments, a designated sorting device (not shown) may be configured to divert each container type to a designated processor 200, for example, a sorting device such as any type of a mechanical, electrical, magnetic or other sorter, may divert a glass container to the glass processor 200, metal container to metal processor 200, etc. Such sorting device utilizing a sensor such as an optical sensor, overweight sensor or other type of information gathering device being utilized to identify type of container to be handled.

According to some embodiments, a processor 200 configured to process a specific material, may include a primary processing assembly (not shown) configured to process containers into a first larger size flakes, and a secondary processing assembly (not shown) configured to process the larger size flakes into a second smaller size flakes material. According to some embodiments, the first or secondary processing assemblies may include a rotor and a knife that meshes with the rotor in order to cause all of the first larger size shredded flakes material to be further shredded to the second smaller size shredded flakes material. According to some embodiments, the secondary processing assembly may include a diverter apparatus capable of diverting the first larger size shredded material to the secondary processing assembly.

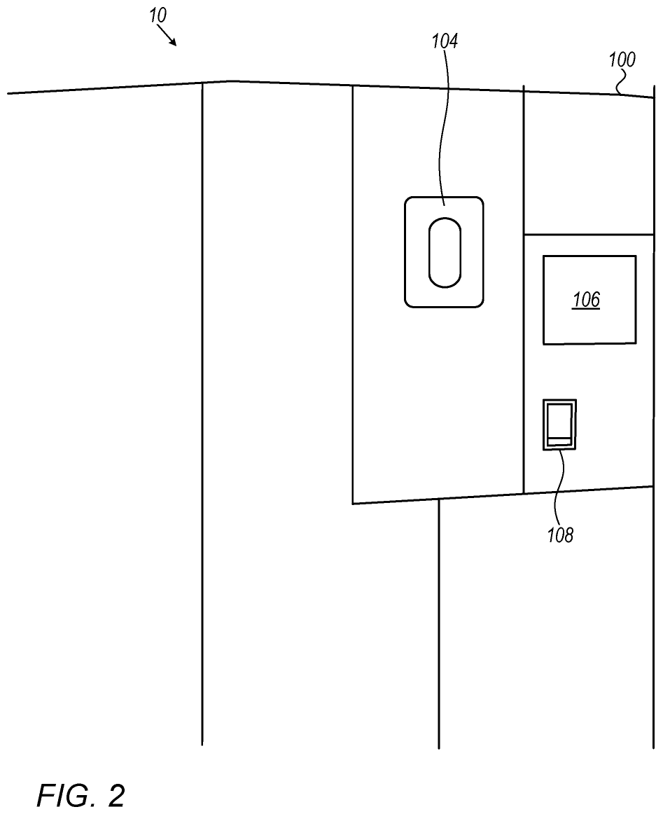

Reference is now made to FIG. 2 which schematically illustrates a RV system 10, according to some embodiments. As shown, the RV system 10 includes an interface compartment 100, (encasing processors and receptacles noted in FIG. 1 as 200 & 300, and does not necessarily include the intermediate section 110). The interface compartment 100 comprises a previously disclosed intake chute 104 designated to allow a user to load a variety of containers into RV system 10 shown in FIG. 1. According to some embodiments, interface compartment 100 may have a contemporary design configured to distinctively stand out and allure user to recycle, for example, intake chute 104 may be adorned by a LED light which will notify the user about the status of the RV system 10, etc.

According to some embodiments, screen 106 is configured to be mounted upon and provide messages, instructions and feedback to a user of the RV system 10, for example, screen 106 may be an immersive touch screen tilted toward the user or any other screen type configured to clearly display data to a user. According to some embodiments, screen 106 may be implemented with a user-friendly touch screen which lets the user to access and modify information on his fingertips, wherein the user interface is kept a minimalistic for easy and quick operation.

According to some embodiments, several types of sensors embedded within the RV system 10 may provide data to a controller configured to monitor and control the operations of the RV system 10. According to some embodiments, the controller may be a PLC, etc. For example, intake chute 104 may be equipped with a position detection sensor configured to provide data regarding the position of the intake door 102, such a position sensor may be an ingress-egress sensor configured to monitor and prevent objects from blocking the entrance of the intake chute 104 when the intake door 102 is raised or lowered. According to some embodiments, should a container fail to completely pass the intake chute 104, the RV system 10 may be disabled by the controller and a warning message may be displayed to the user upon screen 106.

As disclosed above, the controller may be adapted to control the various operations of the RV system 10, hence, a controller may be adapted to control the motion of various components forming the RV system 10 and the various detection means configured to detect containers' parameters. According to some embodiments, the controller is configured to process, store and retrieve data from the various sensors located on or within the RV system 10 in order to detect and process gathered data regarding the containers' parameters.

According to some embodiments, the controller may run a proprietary software program configured to control the operation of the RV system 10 as disclosed above and display messages to the users on screen 106.

According to some embodiments, a ventilation route such as an air vent may be configured as part of the RV system 10 in order to enable cooling, for example, air openings at the lower cover of interface compartment 100 may provide an air flow around critical/heat sensitive components comprising the RV system 10 or for the emission of gasses and smels which may be discharged upon the treatment of containers having debris and remnants of their previously contained material.

Reference is now made to FIG. 3A which schematically illustrates a plastic or metal processor 20 of a RV system 10, according to some embodiments.

As previously disclosed, processor 20 (or processor 40 disclosed in FIG. 3B) may include a double processing apparatus that includes a rotor and a knife that meshes with the rotor in order to initially shred large size shredded flakes and then to the second smaller size shredded flakes. According to some embodiments, the double processing apparatus may include a diverter mechanism (not shown) capable of diverting the first larger size shredded material into the secondary processing mechanism.

As shown, impeller 202 is configured to rotate blade plates (not shown) further configured to shred containers being introduced into processor 20 through hopper 204. According to some embodiment, impeller 202 may be any kind of motor such as an electric motor, hydraulic motor, etc. According to some embodiment, the shredded flakes may exit processor 20 through exit 206 to be collected in a suitable flake storage receptacle/s 300. According to some embodiments, the processor depicted in FIG. 3A is configures to shred plastic and tin forming plastic containers and drinking cans. According to some embodiments, while processing plastic, processor 20 may be configured to produce flakes size of Min 10 mm-Max 20 mm, and while processing metal, processor 20 may be configured to produce flakes size of Min 20 mm-Max 40 mm.

Reference is now made to FIG. 3B which schematically illustrates glass processor 40 of a RV system 10, according to some embodiments. As shown, impeller 402 is configured to rotate blade plates 404 further configured to crush containers being introduced into processor 40 through a hopper (not shown). According to some embodiment, impeller 402 may be any kind of motor such as an electric motor, hydraulic motor, etc. According to some embodiment, the shredded flakes may exit processor 40 through opening 406 to be collected in a suitable flake storage receptacle 300. According to some embodiments, the crusher depicted in FIG. 3B comprises blades adapted for crushing glass made containers and hence, such blades are made more durable than blades adapted to shred softer materials. According to some embodiments, glass processor 40 is designed to prevent long glass bottles from being pushed vertically backward by the shredder blades and potentially cause damage to said blades or apparatus. According to some embodiments, glass processor 40 may be configured to produced flakes size of Min 20 mm-Max 40 mm.

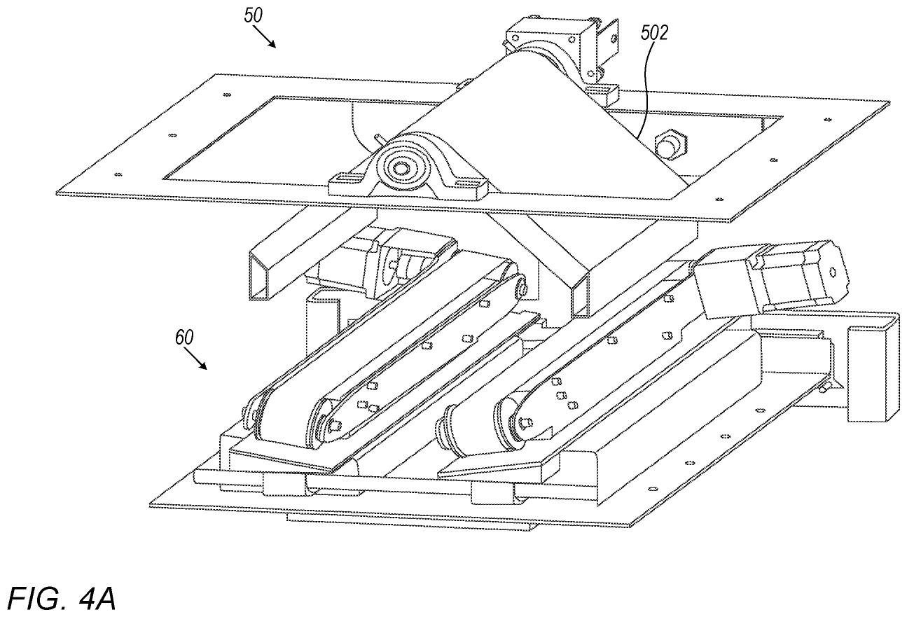

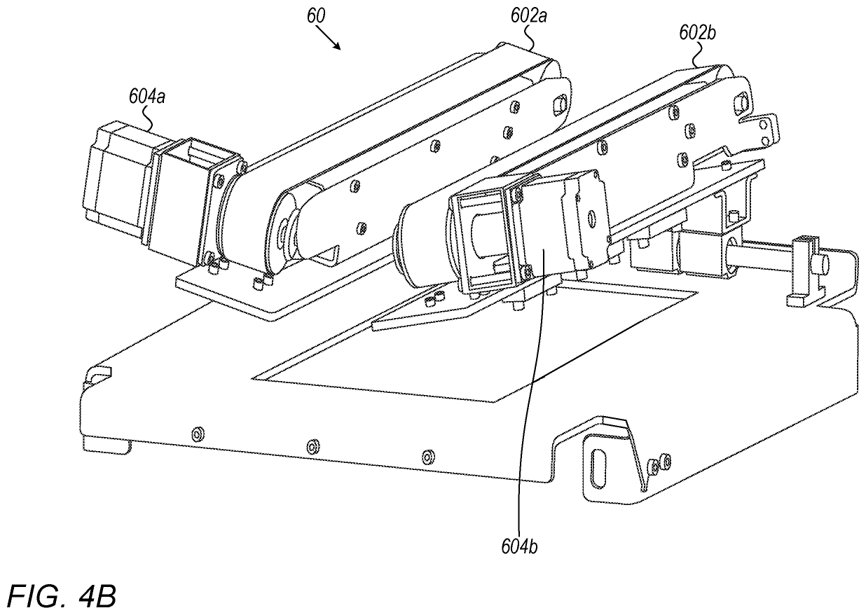

Reference is now made to FIG. 4A which schematically illustrates sorting mechanism 50 of a RV system 10, according to some embodiments. As previously disclosed, the sorting mechanism 50 may be any type of a mechanical sorter and may be configured to divert each container type to a designated processor 20/40.

According to some embodiments, sorter 502 is configured to sort and divert containers introduced into the RV system 10 through chute 104. According to some embodiments, sorter 502 may direct each container to a suitable processor after an inserted container had undergone an identification process conducted by a detection apparatus disclosed herein. According to some embodiments, the sorted container is then conveyed by the conveyor system disclosed in FIG. 4B.

Reference is now made to FIG. 4B which schematically illustrates conveyor apparatus 60 of a RV system 10, according to some embodiments.

As previously disclosed, after a container/s has been inserted to chute 104, a conveyer 60 is configured to convey said container/s into the processors 20/40.

As shown, conveyor belts 602a and 602b are driven by impellers 604a and 604b respectively, and configured to convey any sorted container to a suitable shedder or processor. For example, a glass container may be introduced to the RV system 10 through chute 104, be sorted and diverted by the sorter 502 and be conveyed by conveyors 602a and 602b into the hopper 204 to be shredded by shredders 20/40 in appropriate processor 200 and stored within a designated receptacle 300, etc.

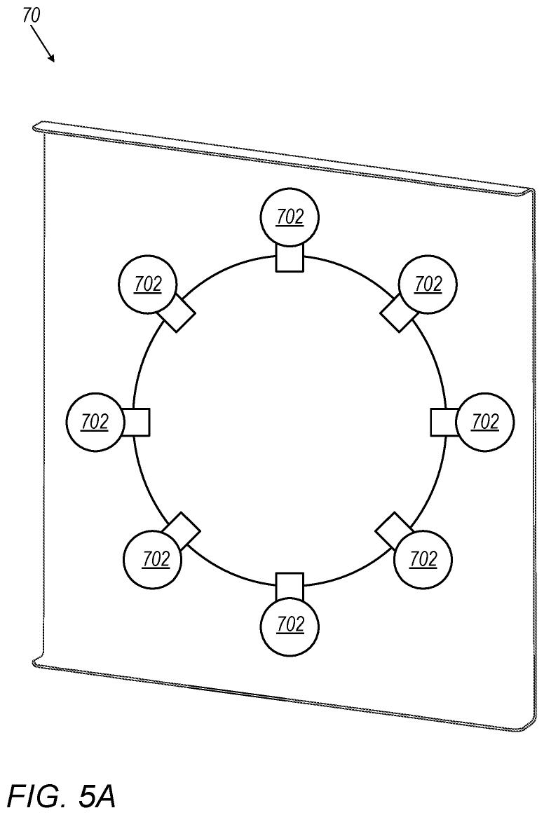

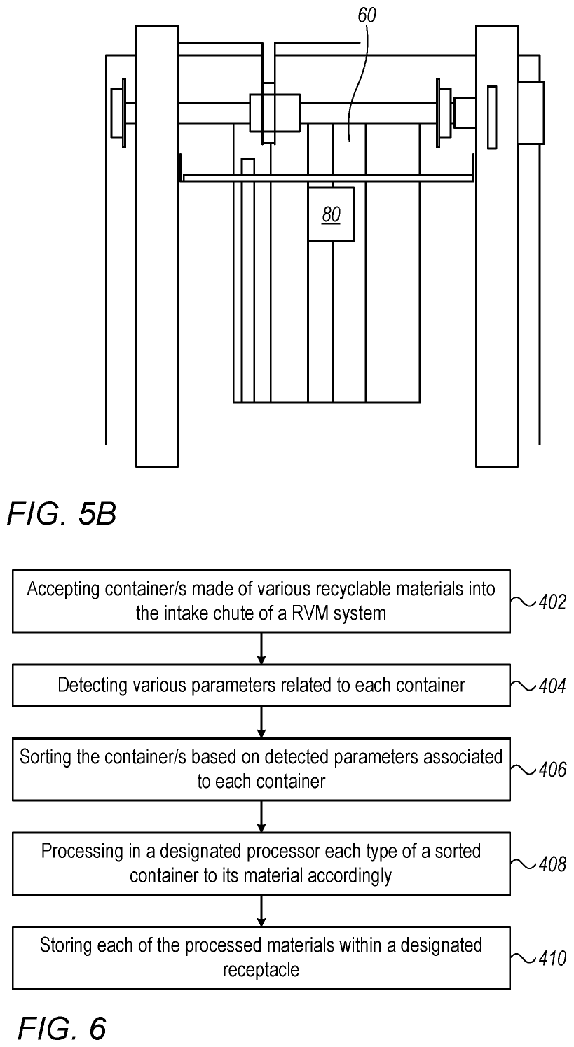

Reference is now made to FIG. 5A which schematically illustrates detection apparatus 70 of a RV system 10, according to some embodiments. As shown, detection apparatus 70 is configured to be in close proximity to intake chute 104 such that a container inserted into the RV system 10 will be identifiable from every angle. According to some embodiments, multiple image capturing devices 702 are arranged on circumference of frame 704 in order to enable capturing a substantially 360 degrees view of every container inserted by the user. According to some embodiments, detection apparatus 70 is configured to be placed at the inner circumference of the insert chute 104 in order to provide fast detection capabilities. According to some embodiments, each image capturing device 702 may be a camera capable of capturing images to be later identified and analyzed by a controller. According to some embodiments, an image capturing device 70 may be a barcode reader capable of reading the barcode of each container and sort it accordingly.

According to some embodiments, multiple image capturing device 702 may partially be cameras while others be designated UPC barcode readers.

Reference is now made to FIG. 5B which schematically illustrates an upper view of conveyor system 60 and an image capturing device 80 forming a part of RV system 10, according to some embodiments. As shown, image capturing device 80 may be configured to be mounted above conveyor 60 in order to have a clear view of containers being sorted and/or conveyed. According to some embodiments, image capturing device 80 may be a camera capable of capturing images to be later identified and analyzed by the controller. According to some embodiments, image capturing device 80 may be a barcode reader capable of reading the barcode of each container and sort it accordingly. According to some embodiments, several capturing devices such as image capturing device 80 of different types (camera, CCD, UV, RF, UPC reader, etc.) can be included in RV system to control the process.

According to some embodiments, the controller may be adapted to control the various operations of the image capturing devices 70/80 by, for example, process, store and retrieve data from the image capturing devices 70/80 in order to detect and process gathered data regarding a containers' features and parameters, and hence providing accurate detection abilities allowing to properly sort a particular container to a designated processor and receptacle.

Reference is now made to FIG. 6 which illustrates a possible operation flow chart of a RV system 10. As shown, in operation 402, a user inserts either single or multiple recyclable container/s made of various materials, into the intake chute 104. For example, the user may insert to said chute 104 containers made of white and light blue plastic, other colored plastic, glass, metal, etc.

According to some embodiments, in operation 404 the RV system 10 applies a detection procedure in order to detect various parameters related to each container. According to some embodiments this detection procedure may rely on various parameters. For example, some parameters that may be assessed by the RV system 10 are the physical properties of the materials forming the sorted containers such as the weight, form, conductivity, spectrographic properties, etc., of each container. Another detection parameter assessed by the RV system 10 may be using a barcode reader capable of reading the barcode of each container and sort it accordingly. According to some embodiments, a substantially 360 degrees barcode scanner/camera may be applied in order to identify a container from various angles.

According to some embodiments, in operation 406 the RV system 10 applies a sorting procedure in order to divert each container to a suitable processor 200. According to some embodiments, the different containers may be washed/cleaned before or after the detecting operation 404 or the sorting operation 406 so as to ease the detection process and/or so as to obtain clean containers/flakes ready for further processing in a recycling facility.

According to some embodiments, in operation 408 the sorted-containers are diverted to a suitable processor 200. For example, containers made out of white and light blue plastic are diverted to a designated processor configured to shred said plastic material into flakes or compress it into transportable bales for further processing by recycling companies. In another example, glass containers may be directed to a designated glass crusher configured to break glass containers into small pieces. In yet another example, metal containers made of tin, aluminum, steel, etc., are diverted into a designated metal processor configured to shred metal containers into metal flakes or compress said containers into transportable bales for further processing by recycling companies. According to some embodiments, the processing of these various materials reduces the volume of the processed containers and allows the processed material to be stored in a compact storage until further processing by recycling companies.

According to some embodiments, in operation 410 processed containers made of a specific material are diverted to a designated receptacle 300 configured to store said material/s. For example, the white and light blue plastic flakes produced by the designated plastic shredder may be diverted into a receptacle 300 designated to store white and light blue plastic flakes.

According to some embodiments, the processed materials produced by the RV system 10 that have been collected or sent to recycling facilities may provide raw materials available for various industries.

Although the present invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. A reverse vending RV system, comprising:
(i) at least one image capturing device,
(ii) a sorting apparatus,
(iii) at least three sets of processors, and
(iv) at least three sets of receptacles,
(v) an interface compartment having an intake chute, and
(vi) a controller configured to control the operation of the RV system,
wherein the intake chute is configured to accept containers made out of various types of recyclable materials,
whereby the sorting apparatus is configured to autonomously sort any container inserted into the intake chute,
wherein each processor is configured to process containers made from predetermined materials,
wherein controller is configured to control the diversion of processed container to appropriate receptacle, and
wherein each receptacle is configured to store processed containers made of predetermined specific materials.

2. The system of claim 1, further configured to accept and autonomously sort a bundle of multiple containers made of various materials jointly loaded into the intake chute.

3. The system of claim 2, wherein intake chute is coupled with a hopper.

4. The system of claim 1, further configured to accept and autonomously sort a single container made out from various materials.

5. The system of claim 1, wherein intake chute is incorporated with a user interface.

6. The system of claim 1, further configured to accept and sort containers in various shapes and sizes.

7. The system of claim 1, further configured to accept and sort deformed containers.

8. The system of claim 1, wherein at least one processor set is configured to process containers made of white and light blue plastic.

9. The system of claim 1, wherein at least one processor set is configured to process containers made of glass.

10. The system of claim 1, wherein at least one processor set is configured to process containers made of metal.

11. The system of claim 1, wherein at least one processor set is configured to process containers made of metal and heavily colored plastics.

12. The system of claim 1, wherein at least one processor incorporates a shredder configured to shred containers into flakes.

13. The system of claim 1, wherein at least one processor incorporates a crusher configured to crush containers into minimal volumes or particles.

14. The system of claim 1, further comprising a user interface configured to provide instructions and feedback to a user.

15. The system of claim 1, further configured to prevent mixing of processed containers made from different materials.

16. The system of claim 1, further comprising an intermediate section configured to connect between the interface compartment and the set of processors such that the interface compartment is accessible to users while the processing operations are conducted in greater distance from the user.

17. The system of claim 1, wherein the at least one image capturing device is a barcode scanner configured to scan the barcode of a particular container.

18. The system of claim 1, wherein the at least one image capturing device is a camera configured to capture images of a particular container.

19. The system of claim 1, wherein the multiple image capturing devices are arranged in a circular formation in order to capture a substantially 360 degree view of a particular container.

20. The system of claim 1, further configured to provide raw material having a reduced volume and favorable recycling qualities.

21. The system of claim 1, wherein the at least three sets of processors are implemented by one processor.

22. A method for using an RV system having at least three sets of processors and at least three receptacles, comprising the steps of:
(i) inserting containers made of various materials,
(ii) detecting features and parameters related to each accepted container,
(iii) sorting the inserted containers based on detected features and parameters related to each container,
(iv) processing each type of material forming a sorted container in a designated processor, and
(v) storing each of the processed containers' materials within a designated receptacle.

23. The method of claim 22, wherein a single processor operates the processing of the at least three processors.
